(19) United States
(12) Patent Application Publication
(10) Pub. No.: US 2011/0016308 A1
(43) Pub. Date: Jan. 20, 2011

(54) ENCRYPTED DOCUMENT TRANSMISSION

(75) Inventor: John EASTMAN, Santa Cruz, CA (US)

Correspondence Address: COOPER & DUNHAM, LLP, 30 Rockefeller Plaza, 20th Floor, NEW YORK, NY, 10112, US

(73) Assignee: RICOH COMPANY, LTD.,, Tokyo (JP)

(21) Appl. No.: 12/505,223

(22) Filed: Jul. 17, 2009

(51) Int. Cl. H04L 9/00; G06F 15/16

(52) U.S. Cl. 713/153; 709/208

(57) ABSTRACT

Apparatuses, systems and methods are provided for secure transmission of data.

### TECHNICAL FIELD

This disclosure relates to secure electronic communication, and more particularly, systems, apparatuses and methodologies for securely communicating electronic documents and data.

### BACKGROUND

In the current information age, information technology (IT) facilities are extensively used in an enterprise (or other organization) environment to communicate electronic documents and data through a network. Further, individuals are communicating large amounts of electronic data to each other on a regular basis through a network, even in a social environment or home environment.

However, transmission of electronic documents and data over a network has vulnerabilities. For instance, the security risks from email communication include the delivery of email to unauthorized destinations, and unauthorized interception of the email communication en route to the intended destination. Information security is particularly important when the documents and data being transmitted are of a sensitive and/or confidential nature.

Further, numerous enterprises must now operate under regulations that increasingly call for provisions that ensure confidentiality of certain communications and protection against unauthorized access of private data during storage and/or transmission of such communications and data. For example, healthcare organizations may be regulated on the manner in which they use email services for electronic transmission of protected patient health information. Similarly, banking and financial institutions may be required to ensure secure transmission, receipt and storage of data corresponding to a consumer's financial and/or non-public personal information.

Data encryption is an approach often utilized for ensuring security of an electronic data transmission. However, even when electronic documents and data are encrypted, such encryption often only takes place after the electronic document or data has been transferred from a source of the document or data to an e-mail server, a network server, or the like. In such a case, the electronic document or data is exposed to security risks while en route to the server, and in some instances, integrity of the document or data may be dubious.

Moreover, even if conventional encryption techniques are applied prior to transmission, such approaches still have drawbacks.

For example, a common form of encryption is symmetric key encryption, wherein electronic data is encrypted using a symmetric key that is generally also necessary for the decryption of that data. The symmetric key is shared secretly between the sender and destination, and the destination of the encrypted data must have access to the same symmetric key. Such an approach has the drawback that the symmetric key used to encrypt that data must be transmitted to, or otherwise obtained by, the data destination in order for the destination to have access to the unencrypted data. However, such sharing of the symmetric key greatly increases the chances that a potential attacker may obtain the symmetric key and use it to decrypt the data.

Another form of encryption, which is generally considered more secure than symmetric key encryption, is public-key encryption. For example, the RSA algorithm is commonly used for public-key encryption, and generates a pair of reusable keys, including a public key used for encrypting data, and a private key different from the public key that is necessary for decrypting that data. The public key may be widely distributed with or without security measures, while the corresponding private key is ideally kept secret. In such an instance, a message encrypted using the public key is transmitted to the designated destination, and only the corresponding private key can be used to decrypt the message.

However, encryption and decryption using the RSA algorithm for public-key encryption is both complex and time-consuming, and can consume a large amount of processing power and system resources. In particular, public-key encryption is not well suited for the encryption of large electronic documents. Moreover, since every destination of electronic documents may have a public key, key management becomes impractical on both a local and global scale, as it may become difficult to obtain and keep track of the large number of public keys corresponding to the many potential destinations.

There exists a need for an improved approach for securely transmitting electronic data and documents over a network, utilizing encryption and decryption techniques that are efficient and not as difficult to use (as a practical matter).

### SUMMARY

This disclosure provides tools (in the form of apparatuses, methodologies and systems) for secure transmission of electronic data.

In an aspect of this disclosure, a specific encryption key is generated, and an electronic document is encrypted using the specific encryption key, to generate an encrypted electronic document. The specific encryption key itself is then encrypted by utilizing a first public key corresponding to a specified destination, to generate an encrypted encryption key. Thereafter, the encrypted electronic document and the encrypted encryption key are transmitted to the specified destination.

In another aspect of this disclosure, a network apparatus is configured to communicate with a key host server through a network. The network apparatus communicates with the key host server to obtain a first public key corresponding to a specified destination of an electronic data transmission. The key host server may include a look-up table that lists a plurality of e-mail addresses and respective public keys corresponding to the e-mail addresses.

In another aspect of this disclosure, a terminal for securely performing electronic communication with a sending network apparatus through a network includes a key generation part configured to generate a first public key and a corresponding private key and upload the first public key to a key host server connected to said network, a receiving part configured to receive from the sending network apparatus an electronic data transmission encrypted by the sending network apparatus using the public key, and a decryption part configured to decrypt the electronic data transmission using the corresponding private key.

### BRIEF DESCRIPTION OF THE DRAWINGS

The above-mentioned and other features, aspects and advantages can be more readily understood from the following detailed description with reference to the accompanying drawings wherein:

FIG. 1 shows a block diagram of a system, according to an exemplary embodiment of this disclosure;

FIG. 2 shows a block diagram of a system, according to another exemplary embodiment of this disclosure;

FIG. 3 shows a block diagram of a system, according to another exemplary embodiment of this disclosure;

FIG. 4 shows an example of a look-up table;

FIG. 5 shows a block diagram of an exemplary configuration of a key host server shown in FIG. 2;

FIG. 6 shows a block diagram of an exemplary configuration of a terminal shown in FIG. 1;

FIG. 7 shows a block diagram of an exemplary configuration of a multi-function device which can serve as a network apparatus;

FIG. 8 shows a schematic view of an example of data flow in an exemplary embodiment.

FIG. 9 shows a flow chart illustrating an example of a workflow on a network apparatus side, in an exemplary embodiment;

FIG. 10 shows a flow chart illustrating a more detailed example of a workflow on a network apparatus side;

FIG. 11 shows a flow chart illustrating an example of a workflow on a terminal side, in another exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

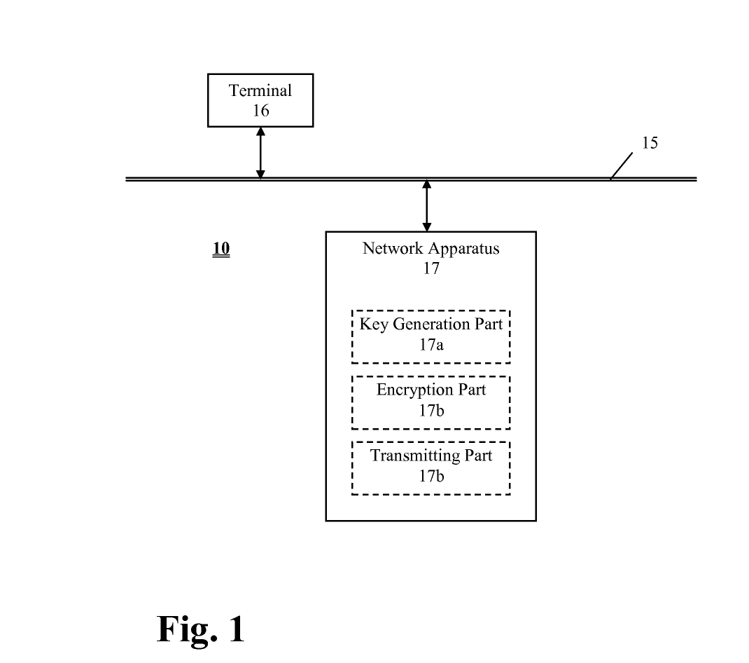

Referring now to the drawings, wherein like reference numerals designate identical or corresponding parts throughout the several views, FIG. 1 shows schematically a system for secure encryption and transmission of electronic documents and data, according to an exemplary embodiment of this disclosure.

System 10 includes a terminal 16 and network apparatus 17, both of which are interconnected by a network 15.

Network apparatus 17 includes a key generation part 17a, an encryption part 17b, and a transmitting part 17c.

The key generation part 17a is configured to generate a specific encryption key that will be used to encrypt an electronic document. In one exemplary embodiment of the present application, the specific encryption key is a symmetric key (also known as a shared key) generated using a known symmetric key algorithm.

The encryption part 17b is configured to encrypt the electronic document using the specific encryption key generated by the key generation part 17a, to thereby generate an encrypted electronic document. Further, the encryption part 17b is also configured to encrypt the specific encryption key itself, using a first public key corresponding to the specified destination of the electronic document, to thereby generate an encrypted encryption key. In a preferred embodiment of the present application, the first public key is generated using the RSA algorithm for public key encryption.

The transmitting part 17c is configured to electronically transmit the encrypted electronic document and the encrypted specific encryption key to the specified destination, such as terminal 16. For example, the transmitting part may be configured to transmit the encrypted electronic document and the encrypted specific encryption key in an e-mail message to the e-mail address corresponding to the specified destination.

Thus, according to this exemplary embodiment of the present invention, there is provided the tools for efficient and secure encryption of electronic data and documents, using two levels of encryption that combine the advantages of both symmetric key encryption and public key encryption techniques. The ‘first level’ of encryption involves encrypting an electronic document using a specific encryption key, such as a symmetric key. This process is relatively fast, and allows for even large electronic documents to be encrypted without consuming a great amount of processing power. However, the symmetric key must also be transmitted to the destination, in order to decrypt the encrypted electronic document. Thus, the ‘second level’ of encryption involves encrypting the specific encryption key itself, using a first public key corresponding to a specified destination, to generate an encrypted encryption key. The first public key, and a corresponding private key, may be generated using the RSA algorithm for public key encryption. This ensures that the specific encryption key shared between the sender and destination remains secure, and that the only the holder of the private key corresponding to the first public key can decrypt the specific encryption key, which may then be used to decrypt the original electronic document. Thus, the integrity and security of the encryption process is greatly increased.

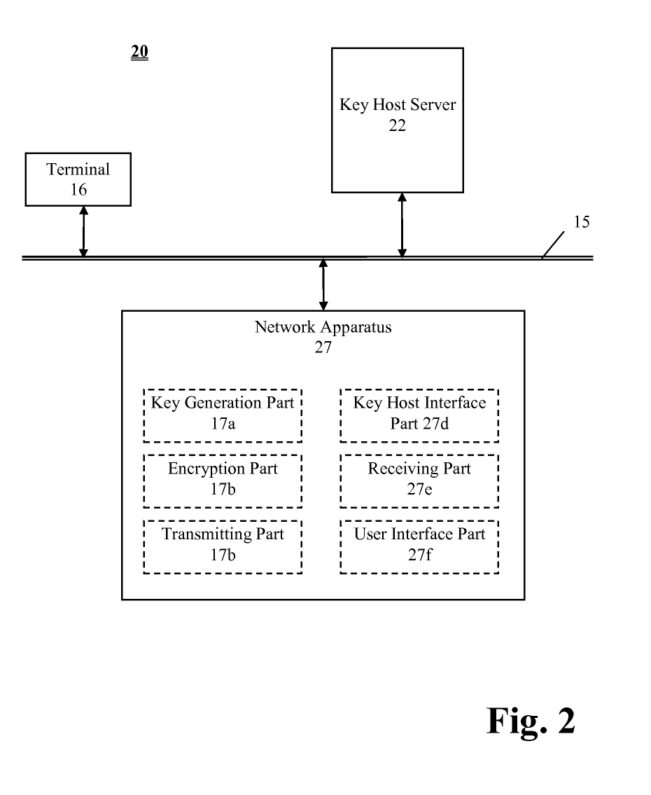

FIG. 2 shows a block diagram of a system, according to another exemplary embodiment of this disclosure. System 20 includes a key host server 22, a terminal 16 and network apparatus 27, all of which are interconnected by a network 15.

The key host server 22 is configured to provide a user interface through the network to a terminal 16, through which a user of terminal 16 can upload identifying information (such as a name or email address) and a respective public key, to the key host server. The key host server 22 may store the uploaded information in a look-up table, which the key host server 22 also makes accessible to a network apparatus 27.

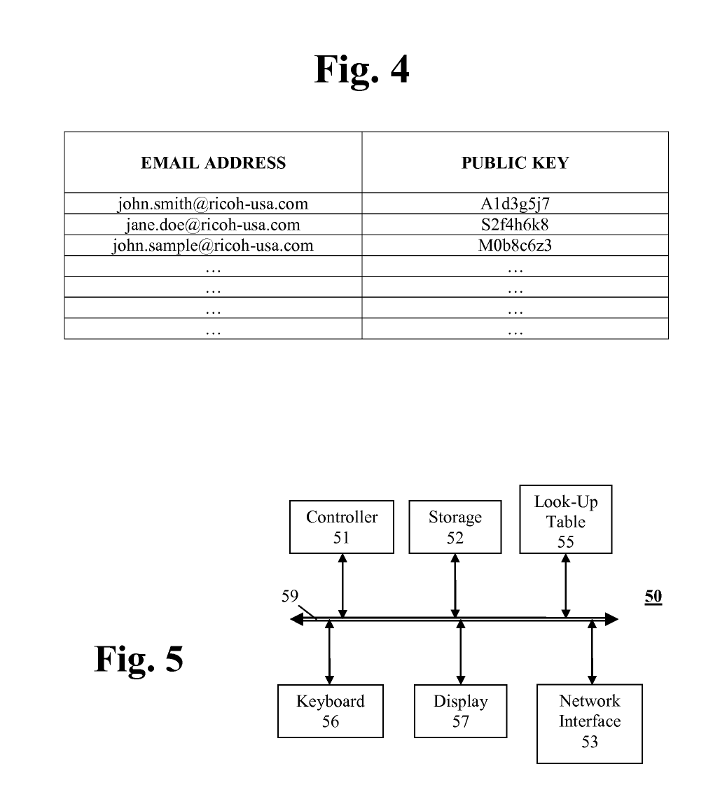

FIG. 4 shows an example of a look-up table in the key host server 22. The look-up table includes a plurality of e-mail addresses (representing a plurality of potential destinations) and respective public keys corresponding to the e-mail addresses, uploaded by at least one terminal such as terminal 16. For example, for the email address “john.smith@ricoh-usa.com” the corresponding public key is A1d3g5j7, and for the email address “jane.doe@ricoh-usa.com” the corresponding public key is S2f4h6k8.

It should be apparent that the look-up table is not limited to the table shown in FIG. 4 which merely presents an example. In particular, while the look-up table shown FIG. 4 depicts e-mail addresses, the look-up table can instead (or in addition) store various other information that may be used to identify a potential destination of an electronic data transmission. For example, the look-up table can include a plurality of names and/or screen names and/or facsimile numbers, etc., and the respective pubic keys.

The terminal 16 is configured with software (for example, a browser) allowing the terminal to communicate through the network with a user interface of the key host server 22, through which terminal 16 can upload an e-mail address and the respective public key corresponding to the e-mail address to the key host server 22. The terminal 16 is also configured to communicate with the network apparatus 27 and to receive an encrypted electronic data transmission from network apparatus 27.

Network apparatus 27 is similar to network apparatus 17, except that network apparatus 27 also includes a key host interface part 27d, a receiving part 27e, and a user interface part 27f. The key generation part 17a, encryption part 17b, and transmitting part 17c, are substantially similar to those of network apparatus 17 depicted in FIG. 1.

The key host interface part 27d is configured to access the key host server 22 to obtain a first public key corresponding to a specified destination of an electronic document. For example, the key host interface part 17b may be configured to access a look-up table in the key host server to obtain a first public key associated with an email address corresponding to the specified destination. This first public key obtained from the key host server 22 may then be used by encryption part 17b to encrypt the specific encryption key, as described above with reference to FIG. 1.

User interface part 27f is provided for user designation of the email address corresponding to the specified destination.

Receiving part 27e is configured to receive an unencrypted electronic document from a second network apparatus. Thus, while network apparatus 27 may be the source of an electronic document, receiving part 27e also allows for the scenario of receiving an unencrypted electronic document from a second network apparatus, or any other device configured to communicate over a network, where the electronic document is designated for electronic transmission to a specified destination.

Thus, according to this exemplary embodiment of the present invention there is provided the tools, systems and methods for efficient and secure encryption of electronic data and documents, whereby potential destinations of an electronic data transmission may upload public keys to a key host server for wide distribution throughout a network, and whereby a network apparatus may access the key host server to obtain a public key corresponding to a specified destination of an electronic data transmission. Thus, a network apparatus that is the source of an electronic data transmission may directly obtain a public key corresponding to specified destination of the electronic data transmission, and data may be immediately encrypted at the source. Thus, the efficiency and integrity of the encryption process is greatly increased.

While the example shown in FIG. 2 includes one key host server 22, one terminal 16 and one network apparatus 27, it should be appreciated that such numbers of servers, terminals and network apparatuses are arbitrary and are selected as an example in order to facilitate discussion, and that the subject matter of this disclosure can be implemented in a system including one or more servers, terminals and network apparatuses. Further, it is noted that a terminal and a server can be included in one integrated device, and similarly a network apparatus and a server can be included in one integrated device (or of course can be separate devices).

In a preferred embodiment of the present application, the network apparatus 17 (or network apparatus 27) is a multi-function device configured to perform a copier function, a scanning function and a printing function. However, network apparatus 17 (or network apparatus 27) can be any computing device, including but not limited to a personal, notebook or workstation computer, a kiosk, a PDA (personal digital assistant), a mobile phone or handset, another information terminal, etc., that can communicate through the network 15 with other devices.

The terminal 16 can be any computing device, including but not limited to a personal, notebook or workstation computer, a kiosk, a PDA (personal digital assistant), a MFD (multi-function device), a mobile phone or handset, another information terminal, etc., that can communicate through the network 15 with other devices. Although only one terminal is shown in FIGS. 1-2, it should be understood that the systems 10-20 can include a plurality of terminal devices (which can have similar or different configurations).

The key host server 22 can comprise one or more structural or functional parts that have or support a storage function. For example, the key host server 22 can be, or can be a component of, a source of electronic data, such as a web server, a backend server connected to a web server, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

The network 15 can include one or more of a secure intranet or extranet local area network, a wide area network, any type of network that allows secure access, etc., or a combination thereof. Further, other secure communications links (such as a virtual private network, a wireless link, etc.) may be used as well in the network 15. In addition, the network 15 preferably uses TCP/IP (Transmission Control Protocol/Internet Protocol), but other protocols can also be used. How devices can connect to and communicate over the network 15 is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

FIG. 5 shows an exemplary constitution of a server that can be configured through software to provide key host server 22. As shown in FIG. 5, server 50 includes a controller (or central processing unit) 51 that communicates with a number of other components, including memory or storage part 52, network interface 53, look-up table 55, keyboard 56 and display 57, by way of a system bus 59.

The server may be a special-purpose device (such as including one or more application specific integrated circuits or an appropriate network of conventional component circuits) or it may be software-configured on a conventional personal computer or computer workstation with sufficient memory, processing and communication capabilities to operate as a server and/or web server, as will be appreciated to those skilled in the relevant arts.

In server 50, the controller 51 executes program code instructions that control key host server operations. The controller 51, memory/storage 52, network interface 53, keyboard 56 and display 57 are conventional, and therefore in order to avoid occluding the inventive aspects of this disclosure, such conventional aspects will not be discussed in detail herein.

In the configuration shown in FIG. 5, look-up table 55 corresponds to the look-up table depicted in FIG. 4. While look-up table 55 is shown as separate from storage unit 52, it should be apparent that look-up table 55 may be located within storage unit 52.

The key host server 50 includes the network interface 53 for communications through a network, such as communications through the network 15 with the terminal 16 and network apparatus 27 in FIG. 2. However, it should be appreciated that the subject matter of this disclosure is not limited to such configuration. For example, the key host server may communicate with the network apparatus 27 through direct connections and/or through a network to which the terminal is not connected. As another example, the key host server need not be provided by a server that services client terminals, but rather may communicate with the terminal on a peer basis, or in another fashion.

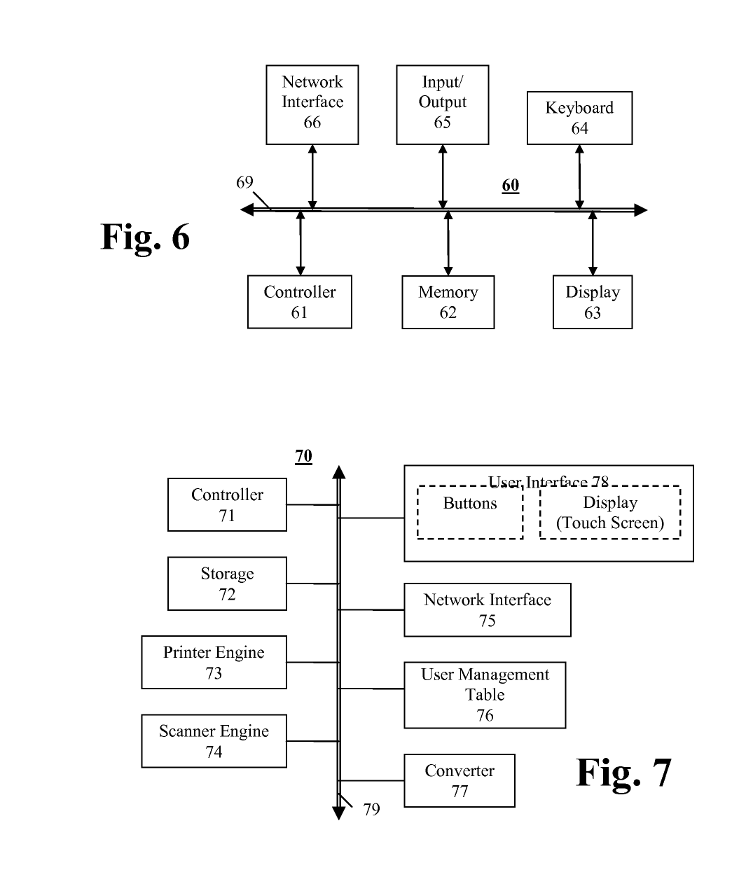

An example of a configuration of the terminal 16 (for example, as a computer) is shown schematically in FIG. 6. In FIG. 6, computer 60 includes a controller (or central processing unit) 61 that communicates with a number of other components, including memory 62, display 63, keyboard (and/or keypad) 64, other input/output (such as mouse, touchpad, stylus, microphone and/or speaker with voice/speech interface and/or recognition software, etc.) 65, and network interface 66, by way of internal bus 69.

The memory 62 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 66 provides a connection (for example, by way of an Ethernet connection or other network connection which supports any desired network protocol such as, but not limited to TCP/IP, IPX, IPX/SPX, or NetBEUI) to network 15.

A user interface is provided and is configured through software natively or received through a network connection, to allow the user to access electronic data or content on the terminal and/or via the network, interact with network-connected devices and services (such as key host server 22), enjoy other software-driven functionalities, etc. For example, a browser (such as Internet Explorer™, Netscape Navigator™, a proprietary browser, etc.) may be provided on the terminal so that a user of the terminal can use browsing operations to communicate with the key host server 22 and/or access other data or content.

Additional aspects or components of the computer 60 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

As mentioned above, the terminal 16 is not limited to a personal computer, but can be manifested in a form of any of various devices that can be configured to communicate over a network and/or the Internet.

FIG. 7 shows an example of a multi-function device (MFD) or multi-functional peripheral device (MFP) which includes copier, scanning and printing functions, and additionally can serve as network apparatus 17 of FIG. 1 or network apparatus 27 of FIG. 2 for transmitting electronic data or documents. In addition, a MFP can include a resident database. Although the network apparatus and the key host server 22 are shown in FIGS. 1-2 as distinct components, it should be understood that such components can be resident within a MFP device.

MFP network apparatus 70 shown in FIG. 7 includes a controller 71, and various elements connected to the controller 71 by an internal bus 79. The controller 71 controls and monitors operations of the MFP 70. The elements connected to the controller 71 include storage 72 (for example, random access memory, read-only memory, hard disk drive, portable storage media drive such as for optical discs, magnetic discs, magneto-optical discs, etc., semiconductor memory cards, combinations of storage media, etc.), printer engine 73, scanner engine 74, network interface (I/F) 75, converter 77 for converting data from one format to another format (for example, a format suitable for printing, faxing, e-mailing, etc.), and user interface 78. The controller 71 also utilizes information stored in user management table 76 to authenticate the user and control user access to the functionalities of the MFP.

Storage 72 can include one or more storage parts or devices, and program code instructions can be stored in one or more parts or devices of storage 72 and executed by the controller 71 to carry out the instructions. Such instructions can include instructions for performing specified functions (such as printing, scanning, faxing, copying, e-mailing, etc.) of the MFP, to enable the MFP to interact with a terminal and/or the key host server as well as perhaps other external devices, through the network interface 75, and to control the converter 77, access data in the user management table 76, and interactions with users through the user interface 78.

The user interface 78 includes one or more display screens that display, under control of controller 71, information allowing the user of the MFP 70 to interact with the MFP. The display screen can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the MFP, so as to allow the operator to interact conveniently with services provided on the MFD, or with the MFD serving as terminal for accessing electronic data or other content through the network. For example, a browser (such as Internet Explorer™, Netscape Navigator™, a proprietary browser, etc.) may be provided on the MFD so that the operator can use browsing operations to access the network. As another example, the operator can scan a document, and use the browser to upload the image data from scanning of the document (and specify additional information associated with the image) to the network.

The display screen does not need to be integral with, or embedded in, a housing of the MFP, but may simply be coupled to the MFP by either a wire or a wireless connection. The user interface 78 may include keys and/or buttons (such as graphical keys or buttons, or other graphical elements, of a GUI on a touchscreen display) for inputting information or requesting various operations. Alternatively, the user interface 78 and the display screen may be operated by a keyboard, a mouse, a remote control, voice recognition, or eye-movement tracking, or a combination thereof.

Since the MFP 70 is typically shared by a number of users, and is typically stationed in a common area, the MFP preferably prompts the user to supply user credential or authentication information, such as user name (or other user or group information), password, access code, etc. The user credential or authentication information can be compared to data stored in the user management table 76 to confirm that the user is authorized to use the MFP. The user credential or authentication information may also be stored for the session and automatically supplied if access to other devices through the network requires it. On the other hand, such other devices may prompt the user to supply other user credential or authentication information through the user interface.

Other methods of authentication may also be used. For example, the multi-function device may be equipped with a card reader or one or more biometrics means (such as comparing fingerprints, palm prints, voice or speech, retinas or irises, facial expressions or features, signature, etc.).

Printer engine 73, scanner engine 74 and network interface 75 are otherwise conventional, and therefore, a detailed description of such conventional aspects are omitted in the interest of clarity and brevity (so as not to mask the novel aspects of the subject matter of this disclosure).

The MFD 70 can have any or all of the functions of similar devices conventionally known, such as for scanning, editing and storing images, sending a fax, sending and receiving e-mails with or without attachments, accessing files by FTP or another protocol or facility, surfing the Web, etc. Further, multi-functional devices or multi-function peripheral devices can play a prominent role to convert hardcopy documents to electronic documents.

As mentioned above, network apparatus 17 and network apparatus 27 are not limited to multi-function devices, but can be manifested in any of various devices that can be configured to communicate over a network and/or the Internet.

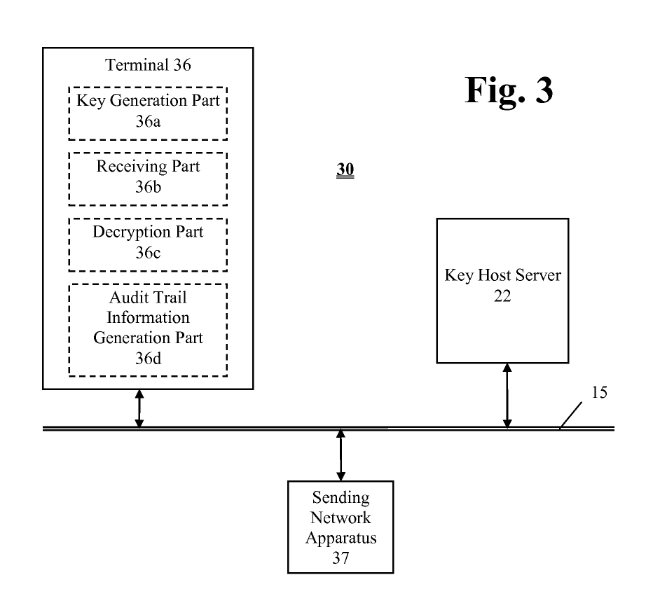

FIG. 3 shows a block diagram of a system, according to another exemplary embodiment of this disclosure. FIG. 3 includes key host server 22, sending network apparatus 37 and terminal 36 connected to network 15. Key host server 22 is identical to the key host server 22 of FIG. 2. Sending network apparatus 37 may be the network apparatus 17 of FIG. 1 or the network apparatus 27 of FIG. 2. Terminal 36 may be terminal 16 of FIGS. 1-2.

Terminal 36 includes a key generation part 36a, a receiving part 36b, a decryption part 36c, and an audit trail information generation part 36d.

The key generation part 36a is configured to generate a first public key and a corresponding private key, using an algorithm for public key encryption as described above (preferably the RSA algorithm for public key encryption). The key generation part is also configured to upload information regarding a specified destination, such as an e-mail address, and the respective first public key corresponding to that e-mail address, to key host server 22.

The receiving part 36b is configured to receive an encrypted electronic data transmission from sending network apparatus 47. Sending network apparatus 47 operates in substantially the same way as network apparatus 17 of FIG. 1 or network apparatus 27 of FIG. 2. That is, sending network apparatus 37 accesses the key host server 22 in order to obtain a first public key corresponding to a specified destination of the electronic data transmission, encrypts the electronic data transmission, and transmits the electronic data transmission to the specified destination, as described in FIGS. 1-2. More specifically, the electronic data transmission received at the receiving part 36b may include: (a) an electronic document, encrypted by the sending network apparatus using a specific encryption key; and (b) the specific encryption key, which is itself encrypted by the sending network apparatus using the first public key obtained from the key host server 22.

The decryption part 36c is configured to decrypt the electronic data transmission. More specifically, the decryption part 36c is configured to: (a) decrypt the encrypted specific encryption key using the corresponding private key, to thereby generate a decrypted specific encryption key (using an algorithm for public-key decryption, such as the RSA algorithm), and (b) decrypt the encrypted electronic document using the decrypted specific encryption key.

The audit trail information generation part 36d is configured to generate audit trail information regarding the electronic data transmission and to store the audit trail information in an audit trail information storage device (e.g. random access memory, read-only memory, hard disk drive, portable storage media drive such as for optical discs, magnetic discs, magneto-optical discs, etc., semiconductor memory cards, combinations of storage media, etc.).

The audit trail information may include metadata describing a sender and destination of the electronic data transmission, a name of at least one document in the electronic data transmission, the number of pages of at least one document in the electronic data transmission, a time of transmission of the electronic data transmission, and a reception time of the electronic data transmission.

Moreover, the audit trail information storage device may store enterprise-wide audit trail information, that is, enterprise-wide audit trail information describing one or more electronic data transmissions received at one or more terminal apparatuses connected to a private enterprise network.

It is important to note that while system 30 shown in FIG. 3 shows only one terminal 36 (and similarly the systems 10-20 shown in FIGS. 1-2 show only one terminal 16), these systems can include a plurality of such terminals. In particular, a first terminal with the configuration of terminal 36 may be used to generate a first public key and corresponding private key and to upload the public key to the key host server 22. Thereafter, a second terminal also with the configuration of terminal 36 may be used to: receive an electronic data transmission encrypted using the first public, decrypt the electronic data transmission with the use of the corresponding private key, and generate audit trail information regarding the electronic data transmission. That is, a “specified destination” of an electronic data transmission such as an e-mail message, as described in the present application, may be one of a plurality of terminals connectable to a network.

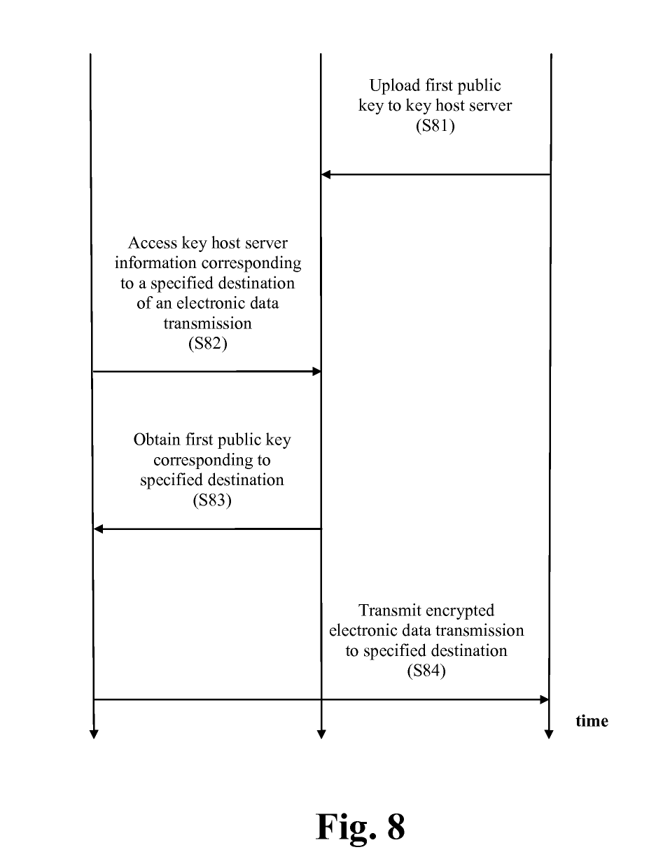

Turning now to FIG. 8, a schematic view of an example of data flow in an exemplary embodiment is presented. A terminal uploads a first public key to a key host server (S81). Thereafter, a network apparatus connects to the key host server and accesses information in the key host server corresponding to a specified destination of an electronic data transmission (S82). The network apparatus then obtains from the key host server a first public key corresponding to the specified destination of the electronic data transmission (S83). Finally, the network apparatus transmits an encrypted electronic data transmission to the specified destination (S84). The encrypted electronic data transmission includes an electronic document that is encrypted using a specific encryption key, and further includes the specific encryption key that is itself encrypted using the first public key obtained from the key host server in (S83).

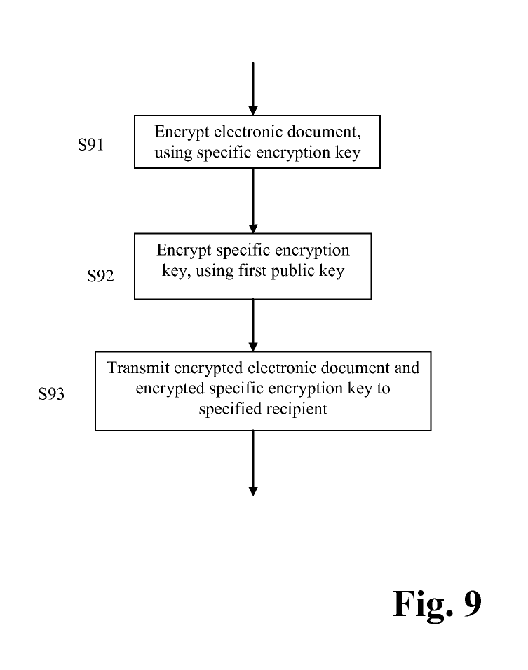

In FIG. 9, a flow chart is shown illustrating an example of a workflow on a network apparatus side (such as the network apparatus 17 in FIG. 1).

Firstly, the network apparatus encrypts an electronic document using a specific encryption key (S91). The specific encryption key is preferably a symmetric key generated using an algorithm for symmetric key encryption. The specific encryption key may be generated at either the network apparatus itself, or at any other apparatus configured to communicate with the network apparatus through a network.

After the network apparatus has encrypted the electronic document using the specific encryption key, the network apparatus encrypts the specific encryption key itself, using a first public key corresponding to a specified destination of the electronic document (S92). The public key is preferably generated using the RSA algorithm for public key encryption.

Finally, the network apparatus transmits the encrypted electronic document and the encrypted specific encryption key to the specified destination (e.g. by transmitting to the email address corresponding to the specified destination) (s93).

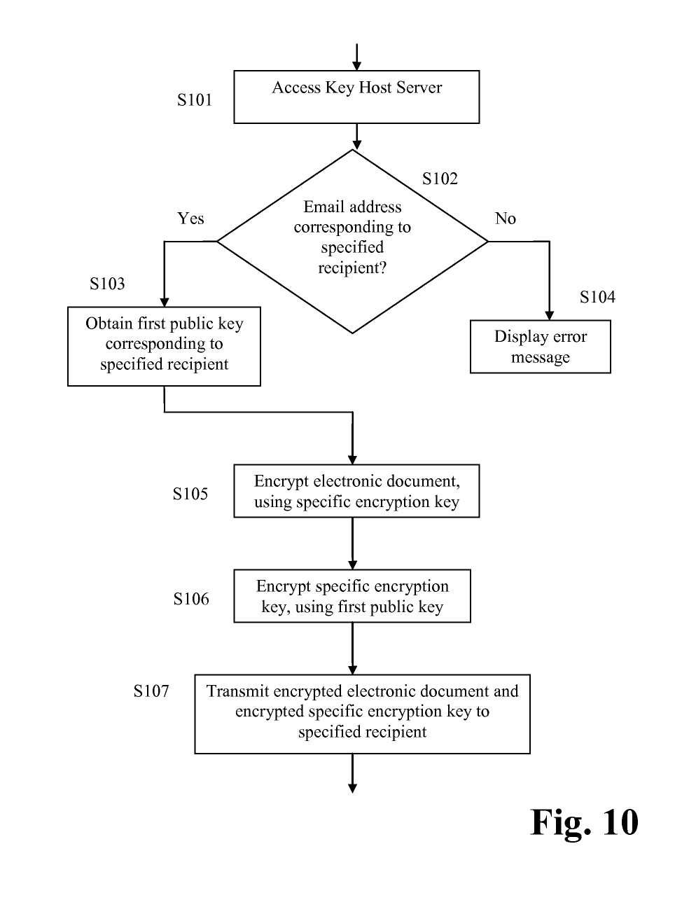

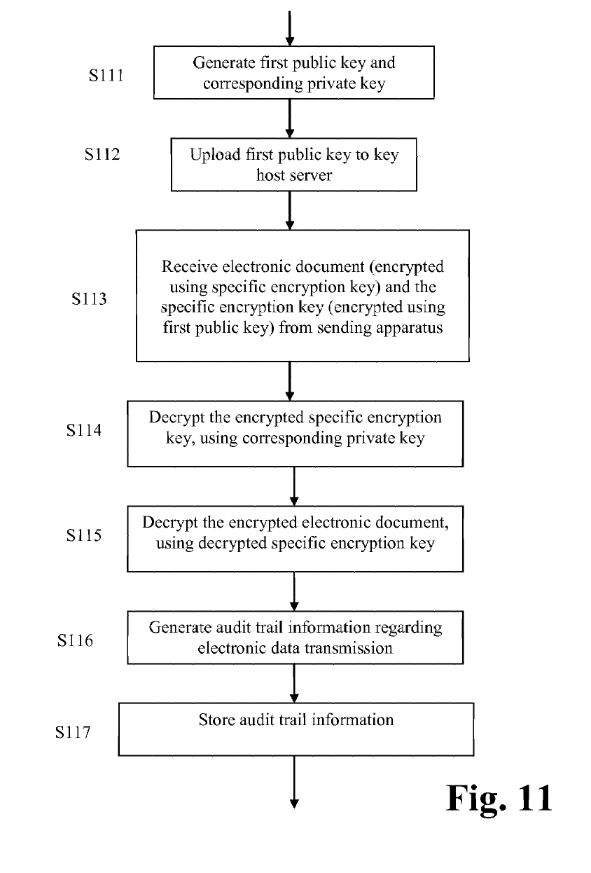

In FIG. 10, a flow chart is shown illustrating a more detailed example of a workflow on a network apparatus side.

In the example of FIG. 10, the network apparatus first accesses a key host server (S101). The network apparatus determines whether information identifying a specified destination of an electronic document is located in the key host server (S102). For example, the network apparatus may access a look-up table in the key host server to locate an e-mail address corresponding to the specified destination.

If the network apparatus determines that such information exists (S102, Yes), then the network apparatus obtains a first public key corresponding to the specified destination from the key host server (S103), preferably from a look-up table in the key host server. On the other hand, if the network apparatus determines that such information does not exist (S102, No), then the network apparatus displays an error message indicating that information regarding the specified destination could not be located in the key host server (S104).

Once the network apparatus obtains the first public key corresponding to the specified destination from the key host server (S103), the network apparatus encrypts the electronic document using a specific encryption key (S105), and encrypts the specific encryption key itself using the first public key obtained from the key host server (S106). As described above, the specific encryption key is preferably a symmetric key, and the first public key is preferably a public key generated using the RSA algorithm for public-key encryption.

Finally, the network apparatus transmits the encrypted electronic document and the encrypted specific encryption key to the specified destination (e.g. by transmitting to the email address corresponding to the specified destination) (s107).

Turning now to FIG. 11, a flow chart illustrating an example of a workflow on a terminal side (such as terminal 36 in FIG. 3) is presented, according to another exemplary embodiment of the present application.

In the example of FIG. 11, the terminal generates a first public key and private key, corresponding to a specified destination (S111). Preferably, the first public key and private key are generated using the RSA algorithm for public-key encryption. The terminal network apparatus then uploads the first public key (as well as information identifying a specified destination e.g. an email address corresponding to a specified destination) to a key host server (S112).

Thereafter, the terminal receives an encrypted electronic document (which is encrypted using a specific encryption key, such as a symmetric key) and also the specific encryption key itself, which is encrypted using the first public key (S113). Note that this corresponds to the first public key that was uploaded to the key host server in S112 and made accessible to a sender of the electronic document.

The terminal then decrypts the encrypted specific encryption key using the corresponding private key (S114), and the terminal decrypts the encrypted electronic document using the decrypted specific encryption key (S115).

Finally, the terminal network apparatus generates audit trail information regarding the electronic data transmission (S116), and stores the audit trail information (S117).

The above-mentioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. An apparatus for secure communication of data through a network, said network apparatus comprising:
a key generation part configured to generate a specific encryption key;
an encryption part configured to encrypt an electronic document by using said specific encryption key, to generate an encrypted document, and encrypt said specific encryption key by utilizing a first public key corresponding to a specified destination, to generate an encrypted encryption key; and
a transmitting part configured to electronically transmit the encrypted document and the encrypted encryption key through the network to the specified destination.

2. The apparatus of claim 1, further comprising:
a key host interface part configured to communicate with a key host server via the network to obtain the first public key corresponding to the specified destination from the key host server.

3. The apparatus of claim 2, further comprising
a user interface part configured for user designation of an e-mail address corresponding to the specified destination, wherein
the key host interface part accesses the key host server and utilizes the user-designated e-mail address to obtain the first public key corresponding to the e-mail address.

4. The apparatus of claim 2, wherein said key host interface part retrieves the first public key from a look-up table in the key host server, and said look-up table registers a plurality of e-mail addresses and corresponding public keys, each of the e-mail addresses being registered with a corresponding one of the public keys.

5. The apparatus of claim 2, further comprising:
a receiving part configured to receive an unencrypted document designated for electronic transmission to the specified destination, from another network device communicating with the apparatus through the network.

6. The apparatus of claim 5, wherein said apparatus operates as a slave server system connected through said network to said another network device.

7. A system comprising:
the apparatus of claim 1; and
a key host server configured to communicate with said apparatus through the network,
wherein said apparatus obtains said first public key corresponding to the specified destination from said key host server through the network.

8. The system of claim 7, wherein said key host server maintains a look-up table configured to register a plurality of e-mail addresses and corresponding public keys, each of the e-mail addresses being registered with a corresponding one of the public keys.

9. The system of claim 7, wherein said key host server is internally hosted on a private enterprise network to which said apparatus is connected, and said system further includes a filtering unit that filters electronic transmissions to said key host server from a source external to said private enterprise network.

10. The apparatus of claim 1, wherein said specific encryption key generated by the key generation part is a symmetric key.

11. A terminal apparatus for performing secure communication of data through a network with a sending device, said terminal apparatus comprising:
a key generation part configured to generate a first public key and a corresponding private key and upload said first public key to a key host server through the network;
a receiving part configured to receive from a sending device through the network encrypted data encrypted by said sending device using said first public key generated by said key generation part; and
a decryption part configured to decrypt said encrypted data by utilizing said corresponding private key generated by said key generation part.

12. The terminal apparatus of claim 11, further comprising an audit trail information generation part configured to generate audit trail information documenting the encrypted data received from the sending device and store said audit trail information in a storage part.

13. The terminal apparatus of claim 12, wherein said audit trail information includes metadata indicating
a sender of the encrypted data,
a destination of the encrypted data;
a name of a document in the electronic data transmission;
a number of pages of a document in the electronic data transmission;
a transmission time of the encrypted data; and
a reception time of the encrypted data.

14. The terminal apparatus of claim 13, wherein the encrypted data corresponds to an electronic document, and said audit trail information further includes metadata indicating a name and a number of pages of the electronic document.

15. The terminal apparatus of claim 11, wherein said key generation part uploads the first public key to a look-up table maintained by said key host server, and said look-up table registers a plurality of e-mail addresses and corresponding public keys, each of the e-mail addresses being registered with a corresponding one of the public keys.

16. The terminal apparatus of claim 11,
wherein said receiving part receives, through the network from a network device, an encrypted data transmission including (a) an electronic document, encrypted by the network device using a specific encryption key, and (b) the specific encryption key, encrypted by the network device using said first public key, and
wherein the decryption part generates a decrypted specific encryption key by decrypting the encrypted specific encryption key using the corresponding private key, and decrypts the electronic document using the decrypted specific encryption key.

17. A method for securely communicating data from a network device through a network, said method comprising:
encrypting an electronic document by an encryption part of the network device utilizing a specific encryption key, to generate an encrypted document;
encrypting said specific encryption key, by the encryption part utilizing a first public key corresponding to a specified destination, to generate an encrypted encryption key; and
transmitting said encrypted document and said encrypted encryption key from the network device through the network to the specified destination.

18. The method of claim 17, further comprising:
communicating by the network device with a key host server via the network to obtain from the key host server the first public key corresponding to the specified destination.

19. The method of claim 17, further comprising:
registering a plurality of e-mail addresses and respective public keys in a look-up table in said key host server, each of the e-mail addresses being registered with a corresponding one of the public keys.

20. The method of claim 17, further comprising:
providing a document storage and retrieval service through the network; and
receiving an unencrypted document designated for electronic transmission to the specified destination.
